(19) United States
(12) Patent Application Publication
(10) Pub. No.: US 2015/0169188 A1
(43) Pub. Date: Jun. 18, 2015

(54) SYSTEM FOR RECEIVING REPEATING TIME INTERVALS

(71) Applicant: Google Inc., Mountain View, CA (US)

(72) Inventors: Thomas R. Karlo, San Francisco, CA (US); Akash G. Shah, Fremont, CA (US); Dorington G. Little, San Francisco, CA (US); James Kung, Foster City, CA (US)

(21) Appl. No.: 13/656,454

(22) Filed: Oct. 19, 2012

(51) Int. Cl. G06F 3/0484; G06Q 10/10

(52) U.S. Cl. CPC G06F 3/04842; G06Q 10/1093

(57) ABSTRACT

A system for receiving repeating time intervals may include one or more processors and a memory. The one or more processors may provide, for display, an interface for inputting a time interval that repeats over a period of time. The interface may include a field for inputting the time interval and selectors for indicating a frequency at which the time interval repeats over the period of time. The one or more processors may receive an indication of a first time interval and a first frequency at which the first time interval repeats over the period of time. The first frequency may be indicated exclusively by a selection of one of the selectors. The one or more processors may provide, for display and in response to the receive, a representation of the first time interval and each instance that the first time interval repeats over the period of time.

### TECHNICAL FIELD

The present description relates generally to receiving time intervals, and more particularly, but not exclusively, to receiving repeating time intervals.

### BACKGROUND

Calendar applications, or other scheduling applications, may allow a user to provide one or more time intervals, such as hours of operation for a business. Although a time interval may be repeated over a period of time, the user may be required to input each repeated time interval individually. For example, if a user is inputting hours of operation for a business, the time interval of 9 AM-5 PM may repeat for weekdays and the time interval of 11 AM-5 PM may repeat for weekend days; however, the user may be required to input the hours of 9 AM-5 PM individually for each weekday and the hours of 11 AM-5 PM individually for each weekend day, both of which may require several steps for the user. The number of required steps may be further compounded if the business is open for two separate time intervals on one or more days, such as from 9 AM-12 PM and 1 PM-5 PM on weekdays. The large number of required steps may not only frustrate users, but may also increase the chances of user input error.

In one or more instances, a calendar application may allow a user to indicate a periodic frequency that a time interval repeats, such as daily. However, the user may need to navigate through multiple interfaces, and/or provide information via multiple interfaces, in order to indicate the periodic frequency at which a particular the time interval repeats. The need to navigate and provide information via multiple interfaces may also be frustrating for the user. The user's frustration may be magnified if the user is navigating and providing input to multiple interfaces via a mobile device, which may have a smaller size screen than a desktop computer. Clicking and navigating through multiple screens of a mobile device may not only frustrate a user, but may also confuse the user, both of which may make the user less likely to use a calendar application, or other scheduling application.

### SUMMARY

The disclosed subject matter relates to a computer implemented method for receiving repeating time intervals. The method may include providing for display, using one or more computing devices, an interface for inputting one or more time intervals that repeat over a period of time, wherein the interface comprises at least one field for inputting the one or more time intervals and a plurality of selectors for indicating one or more frequencies at which the one or more time intervals repeat over the period of time. The method may further include receiving, using the one or more computing devices, a first indication of a first time interval and a first frequency at which the first time interval repeats over the period of time, wherein the first frequency is indicated exclusively by a first selection of a first selector of the plurality of selectors. The method may further include storing, using the one or more computing devices and in response to the receiving, the first time interval and the first frequency at which the first time interval repeats over the period of time.

The disclosed subject matter also relates to a system for receiving repeating time intervals. The system may include one or more processors and a memory including instructions that, when executed by the one or more processors, cause the one or more processors to: provide for display an interface for inputting one or more time intervals that repeat over a period of time, wherein the interface comprises at least one field for inputting the one or more time intervals and a plurality of selectors for indicating one or more frequencies at which the one or more time intervals repeat over the period of time, receive a first indication of a first time interval and a first frequency at which the first time interval repeats over the period of time, wherein the first frequency is indicated exclusively by a first selection of a first selector of the plurality of selectors, and provide for display, in response to the receive, a first representation of the first time interval and each instance that the first time interval repeats over the period of time.

The disclosed subject matter also relates to a machine-readable medium embodying instructions that, when executed by a machine, allow the machine to perform a method for receiving repeating time intervals. The method may include receiving an interface for inputting one or more time intervals that repeat over a period of time, wherein the interface comprises at least one field for inputting the one or more time intervals and a plurality of selectors for indicating one or more frequencies at which the one or more time intervals repeat over the period of time. The method may further include providing a first time interval via the at least one field, and providing a first indication of a first frequency at which the first time interval repeats over the period of time exclusively by selecting a first selector of the plurality of selectors. The method may further include receiving a first representation of the first time interval and each instance that the first time interval repeats over the period of time.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment that may implement a system for receiving repeating time intervals in accordance with one or more implementations.

FIG. 2 illustrates a flow diagram of an example process for receiving repeating time intervals in accordance with one or more implementations.

FIG. 3 illustrates a flow diagram of an example process for providing repeating time intervals in accordance with one or more implementations.

FIG. 4 illustrates an example interface for inputting a repeating time interval in accordance with one or more implementations.

FIG. 5 illustrates an example interface for providing a representation of a repeating time interval in accordance with one or more implementations.

FIG. 6 illustrates an example interface for inputting a repeating time interval in accordance with one or more implementations.

FIG. 7 illustrates an alternative example interface for inputting a repeating time interval in accordance with one or more implementations.

FIG. 8 illustrates a frequency dropdown menu of an alternative example interface for inputting a repeating time interval in accordance with one or more implementations.

FIG. 9 conceptually illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more implementations. In some instances, well-known structures and components are shown in block diagram form in order to avoid obscuring the concepts of the subject technology.

I. Overview

In the subject system for providing repeating time intervals, a user may be provided with a single interface that includes at least one field for providing a time interval, and one or more selectors, such as buttons, for indicating the how often the time interval repeats over a period of time. The interface may also include a spinner, or spinner wheel, for identifying the start time of the time interval and the end time of the time interval. The single interface may be presentable in its entirety on a small screen, such as a screen of a mobile device, without requiring the user to scroll up or down, and without requiring the user to interact with any additional interfaces. Thus, the interface may allow the user to indicate how often the time interval repeats exclusively by selecting one or more of the selectors. In other words, the user may be able to indicate how often the time interval repeats without having to interact with another interface, and in most instances with a single click or a single selection, even if the time interval repeats on an aperiodic basis. The interface may also allow the user to identify multiple intervals that repeat at different frequencies, or the same frequency, over the period of time.

In one or more implementations, the time interval may be a duration of time within a day that repeats on one or more days of a week. In this instance, the interface may include a first field for providing the start time of the time interval, a second field for providing the end time of the time interval and one or more selectors, such as buttons, for indicating which days of the week the time interval repeats on. For example, the interface may include a first button that can be selected by the user to indicate that the time interval repeats only on weekdays, a second button that can be selected by the user to indicate that the time interval repeats only on weekends, and/or a third button that can be selected by the user to indicate that the time interval repeats all days of the week. Thus, the user may indicate which days the time interval repeats on with a single click, or a single selection, without having to navigate to another interface. The user may use the interface to identify durations of time that repeat on the same days, or different days, of the week. For example, the user may use the interface to indicate that the time intervals of 8 AM-11 AM and 1 PM-4PM repeat on weekdays, or that the time interval of 8 AM-11 AM repeats on weekdays and the time interval of 1 PM-4PM repeats on weekends.

Alternatively, or in addition, the interface may include an additional selector, or an additional button, that may be selected by the user in order to provide user customized days of the week that the time interval repeats on, e.g. Monday, Wednesday, and Friday. The user may be provided with an additional interface for indicating the customized days. However, once the customized days of the week have been provided by the user, the interface may include an additional selector, such as a button, that allows the user to re-select the customized days of the week with a single click, or a single selection, which may be useful when a business is open for two distinct time intervals on the same user customized days, e.g. Mondays, Wednesdays, and Fridays.

In the subject system, once the user has indicated the time interval and how often the time interval repeats, the time interval and how often the time interval repeats may be stored, such as by a server in a database. The user may then be provided with a representation of the time interval and of each instance that the time interval repeats on. For example, if the time interval is a duration of time within a day that repeats on various days of a week, the representation may list each day of the week that the duration of time repeats on, and the duration of time may be listed next to each listed day of the week. If the user indicated that multiple time intervals repeat on the same days, such as 9 AM-11 AM and 1 PM-4PM on weekdays, the representation may list the time intervals for the days separately, e.g. one line for 9 AM-11 AM on a given day and another line for 1 PM-4PM on the same day.

The representation may also include selectors associated with the listed days of the week that allow a user to edit the duration of time individually for any of the listed days of the week. If a given day of the week includes more than one duration of time, the representation may include a separate selector for each duration of time for the day. Thus, a user may select the durations of time for the day separately. Alternatively, or in addition, the user may be able to edit the duration of time individually for any of the listed days of the week by clicking, or selecting, any of the listed days of the week and/or by clicking or selecting any of the listed durations of time if any of the days of the week include more than one duration of time. The representation may also include selectors associated with the listed days of the week that allow a user to delete the duration of time individually from any of the listed days of the week. If a given day of the week includes more than one duration of time, the representation may include a separate selector associated with each duration of time for the day. Thus, a user may delete the duration of times for the day separately.

II. Example Network Environments for a System for Receiving Repeating Time Intervals

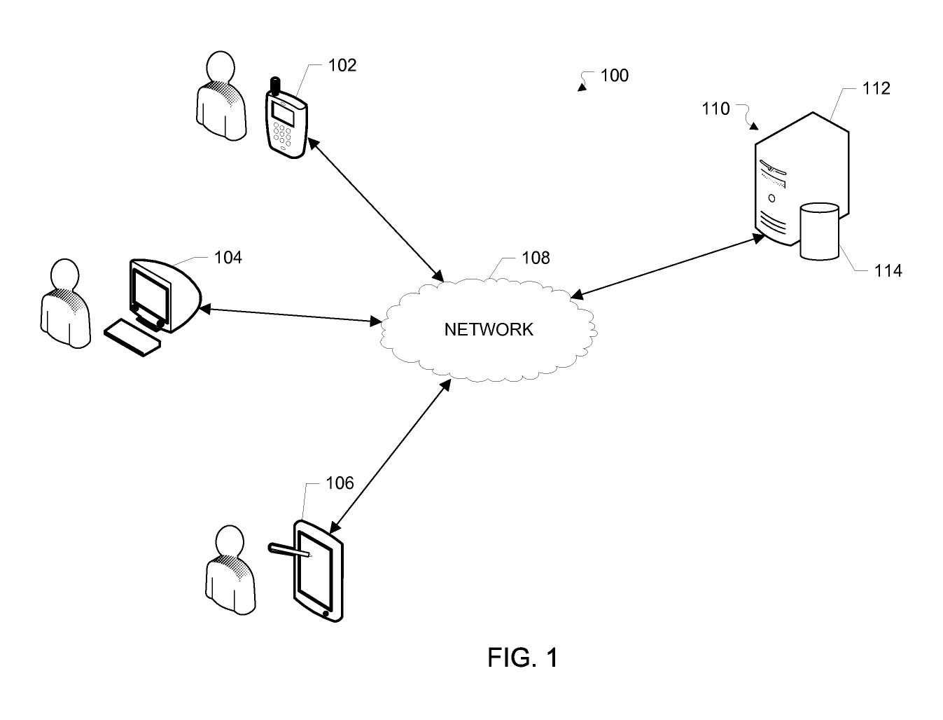

FIG. 1 illustrates an example network environment 100 which may implement a system for receiving repeating time intervals in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The network environment 100 may include a number of electronic devices 102, 104, 106 communicably connected to a server 110, such as by network 108. In another example, some or all of the electronic devices 102, 104, 106 may be communicably connected to one another, such as by the network 108, and some or all of the electronic devices 102, 104, 106 may not be communicably connected to the server 110. The network 108 may be a public communication network (such as the Internet, cellular data network, dialup modems over a telephone network) or a private communications network (such as private local area network (“LAN”), leased lines). The network 108 may also include, but is not limited to, any one or more of the following network topologies, including a bus network, a star network, a ring network, a mesh network, a star-bus network, a tree or hierarchical network, and the like.

In some example implementations, the electronic devices 102, 104 and 106 can be computing devices such as laptop or desktop computers, smartphones, personal digital assistants (“PDAs”), portable media players, tablet computers, televisions or other displays with one or more processors coupled thereto and/or embedded therein, or other appropriate computing devices that can be used to for displaying a web page or web application. In the example of FIG. 1, the electronic device 102 is depicted as a smartphone, the electronic device 104 is depicted as a desktop computer and the electronic device 106 is depicted as a tablet device.

In one example, the server 110 includes a processing device 112 and a data store 114. The processing device 112 executes computer instructions stored in the data store 114, for example, to receive repeating time intervals from one or more of the electronic devices 102, 104, 106. In one or more examples, the data store 114 may store the computer instructions on non-transitory computer-readable medium.

In one example, the server 110 may be a single computing device such as a computer server. In another example, the server 110 may represent more computing devices (such as a cloud of computers and/or a distributed system) that are communicatively coupled, such as communicatively coupled over the network 108, that collectively, or individually, perform one or more functions that can be performed server-side, such as location extraction, query classification, search result retrieval, advertisement retrieval, advertisement serving, and/or generally any functions that can be performed server-side. The one or more computing devices of the server 110 may be geographically collocated and/or the one or more devices may be disparately located. The server 110 may be coupled with various databases, storage services, or other computing devices. The server 110, and the coupled databases, storage services, or other computing devices may be geographically collocated, or may be disparately located.

The server 110 may host a web server that is communicatively coupled to client devices, such as web browsers of client devices (e.g., electronic devices 102, 104 or 106) via the network 108. In one example, the subject system may be provided to the electronic devices 102, 104, 106 by the server 110. In another example, the subject system may be provided to the electronic devices 102, 104, 106 by the server 110 in addition to one or more communicatively coupled remote servers over one or more networks (e.g., network 108).

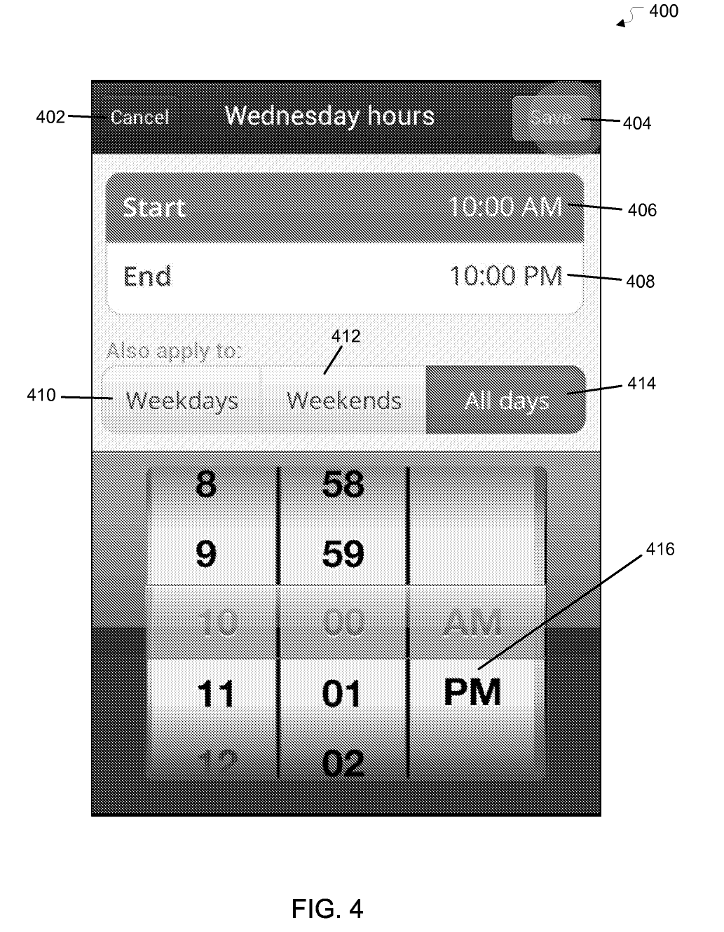

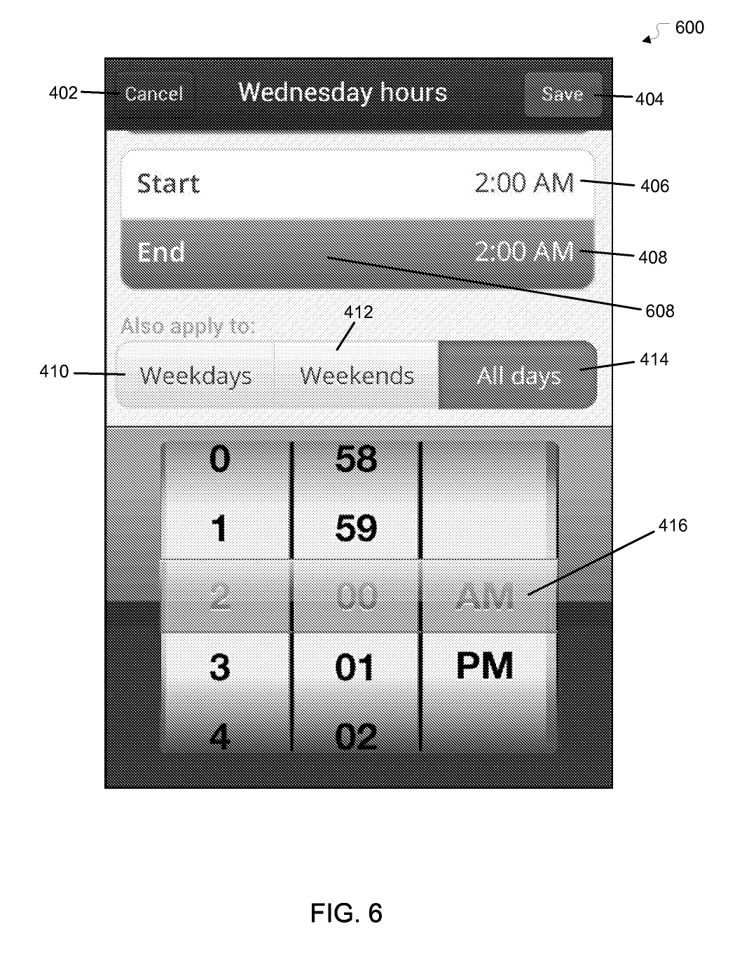

In operation, a user may interact with one of the electronic devices 102, 104, 106, such as the electronic device 102, in order to provide a time interval that repeats over a period of time. The user may input the time interval via an interface, such as a user interface, that is provided to the electronic device 102 by the server 110, such as the interface that is illustrated in FIG. 4, or the interface that is illustrated in FIG. 6. For example, a user may provide a time interval via the interface that corresponds to the business hours that a business is open over the course of a week. In this example, the time interval may be repeated over multiple days, such as weekdays or weekends. Alternatively, or in addition, a user may provide a time interval that corresponds to an event that is repeated on a periodic basis, such as on a weekly basis or on a monthly basis. For example, a user may input a time interval to the electronic device 102, such as a duration of time within a day, along with an indication of a frequency at which the time interval repeats over a period of time, such as a week.

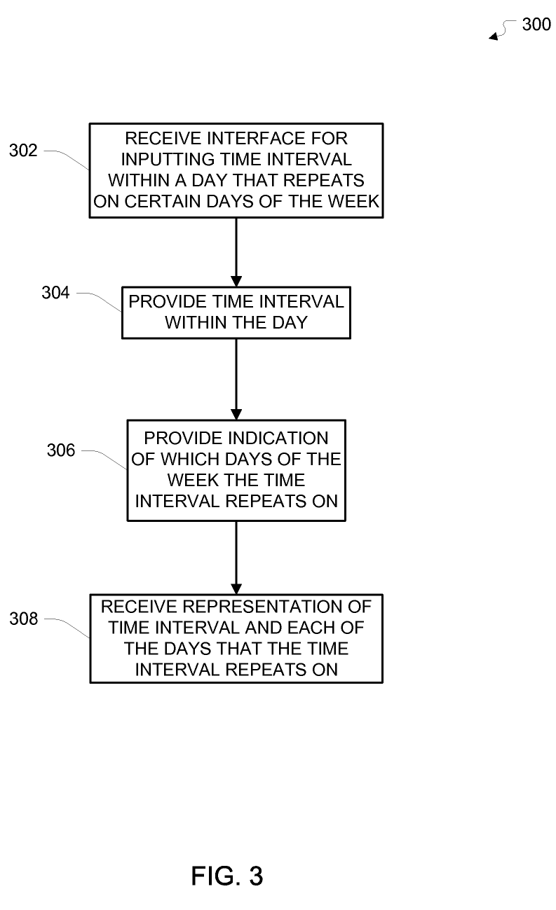

In one or more examples, the interface may include one or more selectors, such as buttons, and the user may indicate the frequency at which the time interval repeats exclusively by selecting one of the selectors. For example, the interface may include individual selectors for indicating that: the time interval repeats on weekdays, the time interval repeats on weekends, and/or the time interval repeats all days. Alternatively, or in addition, the interface may include a dropdown menu that allows a user to select the frequency at which the time interval repeats, such as on weekdays, on weekends, or on all days. The electronic device 102 may provide the time interval and the frequency to the server 110. The process of the electronic device 102 providing the time interval and the frequency to the server 110 is discussed further below with respect to FIG. 3.

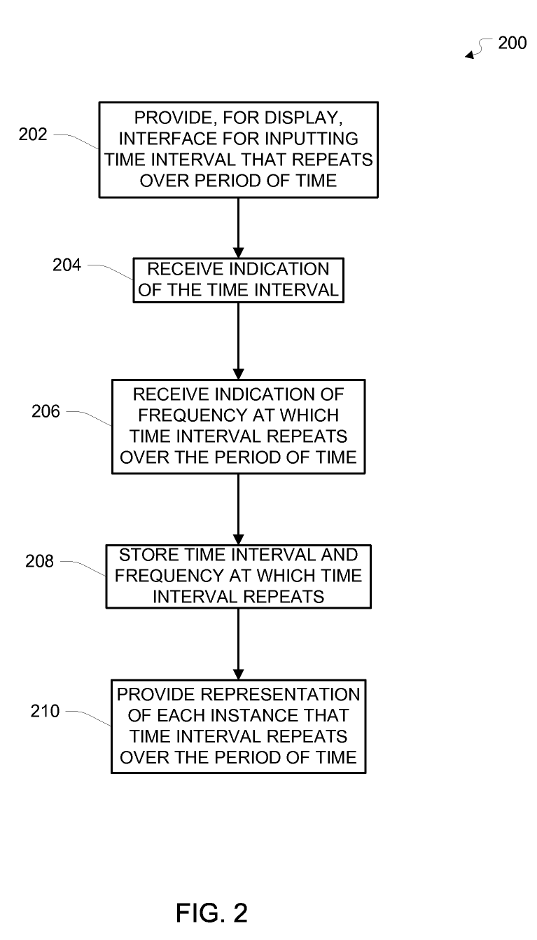

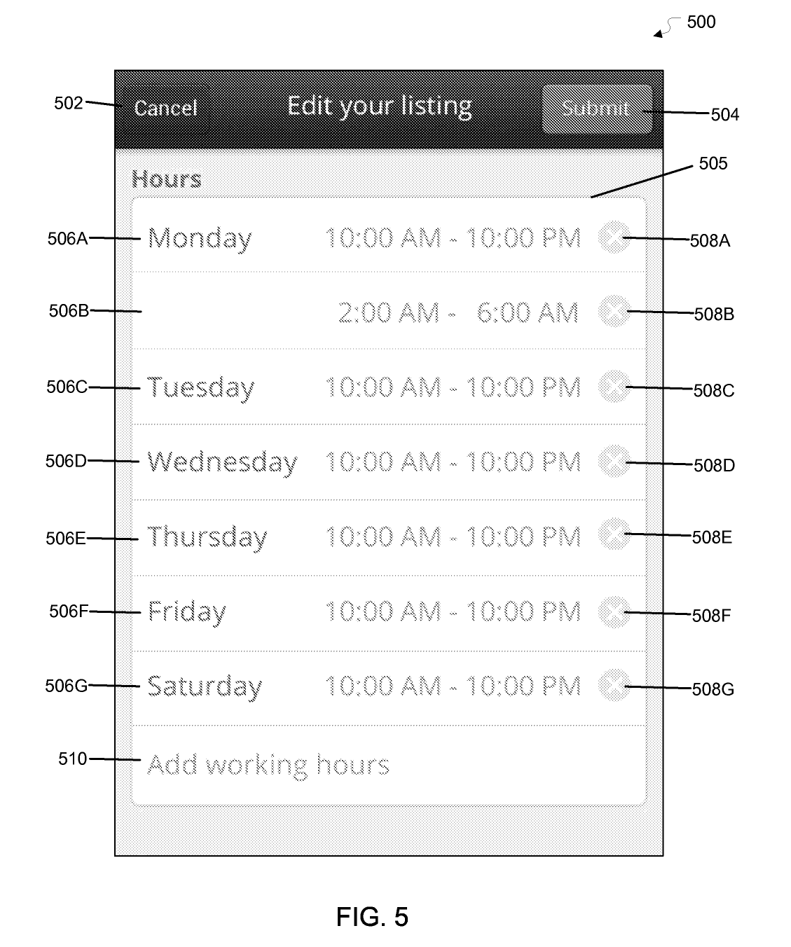

The server 110 may receive the time interval and the frequency that the time interval repeats over a period of time from the electronic device 102. The server 110 may store the time interval and the instances that the time interval is repeated, such as in the data store 114. In one or more examples, the server 110 may be able to determine the frequency that the time interval repeats exclusively based on the selection of one of the selectors, or a selection of a dropdown menu, by the user. The server 110 may also generate a representation of the time interval and each instance that the time interval repeats over the period of time, such as each day that the time interval repeats over a week, and the server 110 may provide the representation to the electronic device 102 for display to the user. For example, the server 110 may provide the representation illustrated in FIG. 5 to the electronic device 102. The process of the server 110 receiving the repeating time interval and providing the representation are discussed below with respect to FIG. 2.

III. Example Processes for a System for Receiving Repeating Time Intervals

FIG. 2 illustrates a flow diagram of example process 200 for receiving repeating time intervals in accordance with one or more implementations. For explanatory purposes, example process 200 is described herein with reference to example network environment 100 of FIG. 1; however, example process 200 is not limited to example network environment 100 of FIG. 1. Further for explanatory purposes, the blocks of example process 200 are described herein as occurring in serial, or linearly. However, multiple blocks of example process 200 may occur in parallel. In addition, the blocks of example process 200 need not be performed in the order shown and/or one or more of the blocks of example process 200 need not be performed.

In block 202, the server 110 provides to one of the electronic devices 102, 104, 106, such as the electronic device 102, for display to a user, an interface for inputting a time interval, such as a duration of time within a day, that repeats over a period of time, such as on a certain days of a week. For example, the server 110 may provide the interface that is illustrated in FIG. 4. In one or more examples, the interface may include selectors, such as buttons, for indicating a frequency that the time interval repeats over the period of time. For example, in the instance of a time period of a week, the interface may include a button for indicating that the time interval repeats on the weekdays of the week, on the weekend of the week, or on all days of the week. Alternatively, or in addition, the interface may include a dropdown menu for indicating the frequency.

In block 204, the server 110 may receive an indication of the time interval from the electronic device 102. In block 206, the server 110 may receive an indication of the frequency at which the time interval repeats over the period of time from the electronic device 102. The indication of the frequency at which the time interval repeats may be determinable exclusively from a selection of one of the selectors by the user. In one or more examples, the server 110 may receive the indication of the time interval substantially contemporaneous to receiving the indication of the frequency that the time interval repeats over the period of time.

In block 208, the server 110 may store the time interval and the frequency that the time interval repeats over the period of time, such as in the data store 114. In one or more examples, the server 110 may store an association between the time interval and each instance that the time interval repeats over the period of time in the data store 114. In block 210, the server 110 may provide a representation of each instance that the time interval repeats over the period of time, such as the representation that is illustrated in FIG. 5. For example, in the instance of a duration of time that occurs within a day and repeats on a number of days of a week, the server 110 may provide a representation of the duration of time for each day that the duration of time repeats on, as illustrated in FIG. 5.

FIG. 3 illustrates a flow diagram of example process 300 for providing repeating time intervals in accordance with one or more implementations. For explanatory purposes, example process 300 is described herein with reference to example network environment 100 of FIG. 1; however, example process 300 is not limited to example network environment 100 of FIG. 1. Further for explanatory purposes, the blocks of example process 300 are described herein as occurring in serial, or linearly. However, multiple blocks of example process 300 may occur in parallel. In addition, the blocks of example process 300 need not be performed in the order shown and/or one or more of the blocks of example process 300 need not be performed.

In block 302, one of the electronic devices 102, 104, 106, such as the electronic device 102, receives an interface for inputting a time interval within a day that repeats on certain days of a week from the server 110. For example, the time interval may be a number of hours during a day that repeats on multiple days of a week. The interface may include one or more selectors that may be exclusively used by a user to indicate the days of the week that the time interval repeats on. In one or more examples, the interface provided by the server 110 may be the interface that is illustrated in FIG. 4.

In block 304, the electronic device 102 may provide the time interval within the day to the server 110. For example, a user may input the time interval to the electronic device 102 via the interface and the electronic device 102 may communicate the time interval to the server 110, such as over the network 108. In block 306, the electronic device 102 may provide an indication of which days of the week that the time interval repeats on to the server 110. For example, a user may input the days of the week that the time interval repeats on to the electronic device 102 via the interface, such as exclusively by selecting one of the selectors or exclusively by selecting an item in a dropdown menu, and the electronic device 102 may communicate an indication of the days of the week to the server 110, such as over the network 108.

In block 308, the electronic device 102 may receive a representation of the time interval and each of the days that the time interval repeats on from the server 110. The electronic device 102 may display the representation to the user. For example, the representation may list the time interval next to each day of the week that the time interval repeats on. In one or more implementations, the electronic device 102 may receive the representation that is illustrated in FIG. 5.

IV. Example Interfaces for Systems for Receiving Repeating Time Intervals

FIG. 4 illustrates an example interface 400 for inputting a repeating time interval in accordance with one or more implementations. Not all of the depicted components of the interface 400 may be required, however, and one or more implementations may include additional components of the interface 400 that are not shown in the figure. Variations in the arrangement and type of the components may be made without departing from the spirit or scope of the claims as set forth herein. Additional, different or fewer components may be provided.

The interface 400 may include a cancel selector 402, a save selector 404, a start time field 406, an end time field 408, one or more selectors 410, 412, 414, and a spinner 416. In operation, the server 110 may provide, for display, the interface 400 to the electronic device 102. The electronic device 102 may display the interface to a user. The user may interact with the interface 400 to provide a start time of a time interval in the start time field 406, e.g. by using the spinner 416, an end time of the time interval in the end time field 408, e.g. by using the spinner 416, and a frequency that the time interval repeats, e.g. exclusively by selecting one of the selectors 410, 412, 414. The electronic device 102 may provide the server 110 with the time interval and the frequency that the time interval repeats when the user selects the save selector 404.

For example, in the interface 400 the user may select the selector 410 to indicate that the time interval repeats on weekdays of the week, the user may select the selector 412 to indicate that the time interval repeats on the weekend of the week, and the user may select the selector 414 to indicate that the time interval repeats on all days of the week. Accordingly, the user may be able to provide an indication of the frequency directly via the interface 400, e.g. without having to interact with another interface. The electronic device 102 may not provide the indication of the time interval and the frequency that the time interval repeats when the user selects the cancel selector 402.

FIG. 5 illustrates an example interface 500 for providing a representation of a repeating time interval in accordance with one or more implementations. Not all of the depicted components of the interface 500 may be required, however, and one or more implementations may include additional components of the interface 500 that are not shown in the figure. Variations in the arrangement and type of the components may be made without departing from the spirit or scope of the claims as set forth herein. Additional, different or fewer components may be provided.

The interface 500 may include a cancel selector 502, a submit selector 504, a representation of repeating time intervals 505, and an add time interval selector 510. The representation of the repeating time intervals 505 may include one or more time intervals 506A-G and one or more delete selectors 508A-G. In operation, the server 110 may provide, for display, the interface 500 that includes the representation 505 to the electronic device 102. The electronic device 102 may display the interface 500 and the representation 505 to the user.

The representation 505 may display a list that includes a repeating time interval along with each day that the time interval repeats over a period of time, such as a week. For example, in FIG. 5, the representation 505 may display the time interval of 10:00 AM-10:00 PM for each day that the time interval repeats on for the week, e.g. Monday-Saturday. As illustrated in FIG. 5, any of the days of the week may be associated with multiple time intervals, such as the time intervals 506A, 506B that are associated with Monday. The user may delete any of the time intervals 506A-G by selecting the associated delete selector 508A-G. The user may add an additional time interval by selecting the add time interval selector 510. The user may edit any of the time intervals 506A-G by selecting any of the time intervals 506A-G, such as by touching or clicking on any of the time intervals 506A-G. In one or more examples, the server 110 may provide the electronic device 102 with the interface 400 in response to the user selecting any of the time intervals 506A-G, and/or in response to the user selecting the add time interval selector 510.

If any of the time intervals 506A-G provided by the user are invalid, such as a time interval having an end time that is before or the same as the start time, or a time interval that does not satisfy any business rule criteria, the representation 505 may include an indication that one of the time intervals 506A-G is invalid, such as by highlighting any invalid time intervals 506A-G in red.

FIG. 6 illustrates an example interface 600 for inputting a repeating time interval in accordance with one or more implementations. Not all of the depicted components of the interface 600 may be required, however, and one or more implementations may include additional components of the interface 600 that are not shown in the figure. Variations in the arrangement and type of the components may be made without departing from the spirit or scope of the claims as set forth herein. Additional, different or fewer components may be provided.

The interface 600 may include a cancel selector 402, a save selector 404, a start time field 406, an end time field 408, one or more selectors 410, 412, 414, a spinner 416, and an indication of an invalid end time 608. In operation, the server 110 may provide, for display, the interface 600 to the electronic device 102. The electronic device 102 may display the interface 600 to a user. The user may interact with the interface 600 to provide a start time of a time interval in the start time field 406, e.g. by using the spinner 416, an end time of the time interval in the end time field 408, e.g. by using the spinner 416, and a frequency that the time interval repeats, e.g. exclusively by selecting one of the selectors 410, 412, 414.

If the user inputs a time interval that is invalid, such as a time interval that has an end time that is before or the same as the start time, or a time interval that doesn't satisfy any business rule criteria, the server 110 and/or the electronic device 102 may provide an indication of the invalid time interval to the user. For example, the server 110 and/or the electronic device 102 may provide an indication of an invalid end time 608 to the user, such as by highlighting the end time field 408 in red. Alternatively, or in addition, the server 110 and/or the electronic device 102 may highlight the start time field 406 in red and/or may provide any other graphical indicia that indicates that the inputted time interval is invalid. In one or more examples, the user may be prevented from saving an invalid time interval. Alternatively, or in addition, the user may be allowed to save the invalid time interval and the server 110 may provide an indication of the invalid time interval in the representation 505 illustrated in FIG. 5.

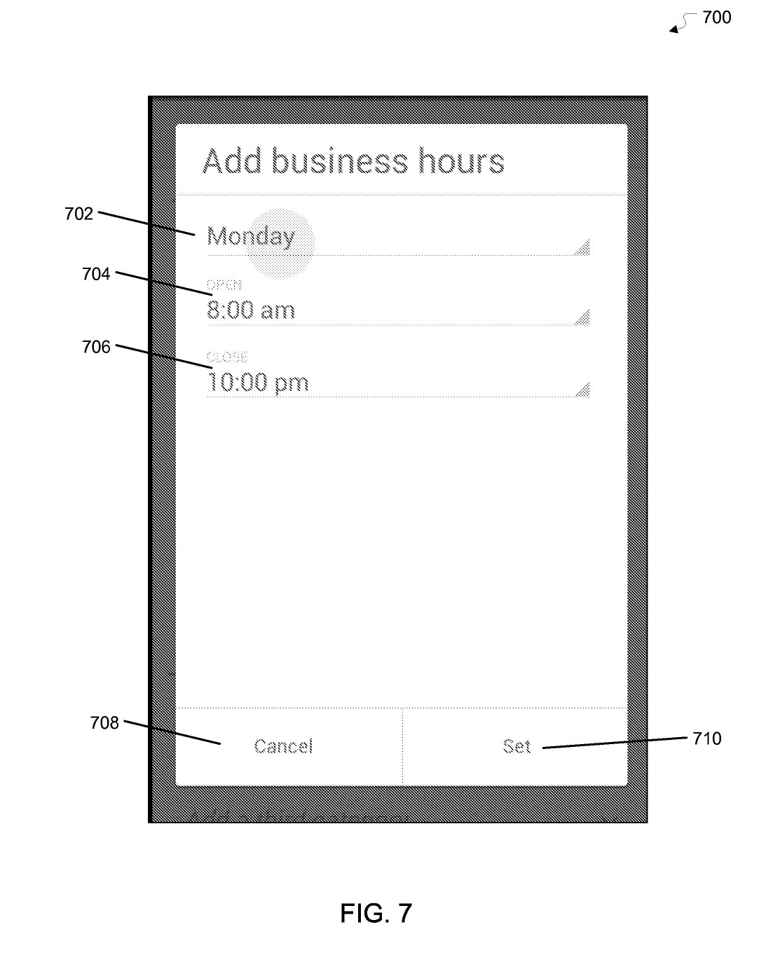

FIG. 7 illustrates an alternative example interface 700 for inputting a repeating time interval in accordance with one or more implementations. Not all of the depicted components of the interface 700 may be required, however, and one or more implementations may include additional components of the interface 700 that are not shown in the figure. Variations in the arrangement and type of the components may be made without departing from the spirit or scope of the claims as set forth herein. Additional, different or fewer components may be provided.

The interface 700 may include a frequency selector 702, a start time selector 704, an end time selector 706, a cancel selector 708, and a set selector 710. In operation, the server 110 may provide, for display, the interface 700 to the electronic device 102. The electronic device 102 may display the interface 700 to a user. The user may interact with the interface 700 in order to provide a start time of a time interval using the start time selector 704, an end time of a time interval in the end time selector 706, and a frequency that the time interval repeats, e.g. exclusively by using the frequency selector 702. In one or more instances, the frequency selector 702, the start time selector 704, and/or the end time selector 706 may be drop down menus that may present multiple selectable values to the user when the user selects any of the selectors 702, 704, 706. For example, the user may be presented with multiple selectable time values when the user selects the start time selector 704 and/or the end time selector 706, and the user may be presented with multiple selectable frequency values, such as weekdays, weekends, etc., when the user selects the frequency selector 702. The electronic device 102 may provide the server 110 with the time interval and the frequency that the time interval repeats when the user selects the set selector 710. The electronic device 102 may not provide the indication of the time interval and the frequency when the user selects the cancel selector 708.

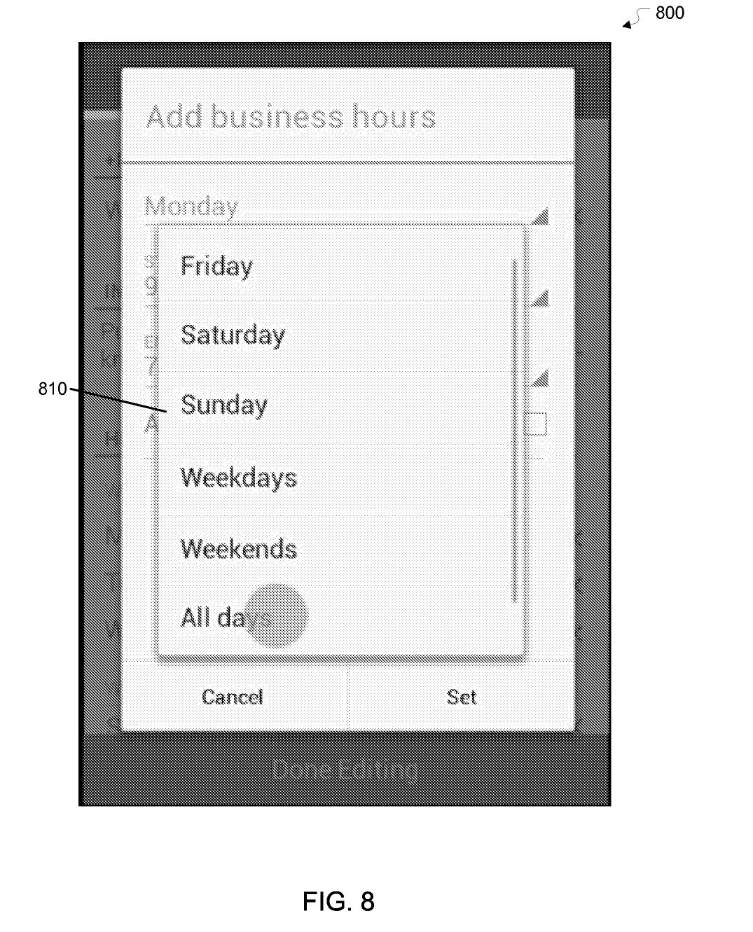

FIG. 8 illustrates a frequency dropdown menu 810 of an alternative example interface 800 for inputting a repeating time interval in accordance with one or more implementations. Not all of the depicted components of the interface 800 may be required, however, and one or more implementations may include additional components of the interface 800 that are not shown in the figure. Variations in the arrangement and type of the components may be made without departing from the spirit or scope of the claims as set forth herein. Additional, different or fewer components may be provided.

The interface 800 may include a frequency dropdown menu 810 that may be presented to the user, e.g., when the user selects the frequency selector 702 of FIG. 7. The frequency dropdown menu 810 may include values that correspond to each day of a week, e.g. Sunday-Saturday, to all weekdays, to weekend days, and to all days. In operation, the user may select one or more of the frequency values to indicate the frequency at which a time interval repeats over a period of time, such as a week. The value displayed in the frequency selector 702 of FIG. 7 may be updated in response to the user selecting one of the frequency values from the frequency dropdown menu 810. The selected frequency value may be provided to the server 110 by the electronic device 102 when the user selects the set selector 710 of interface 700.

V. Example Systems for Receiving Repeating Time Intervals

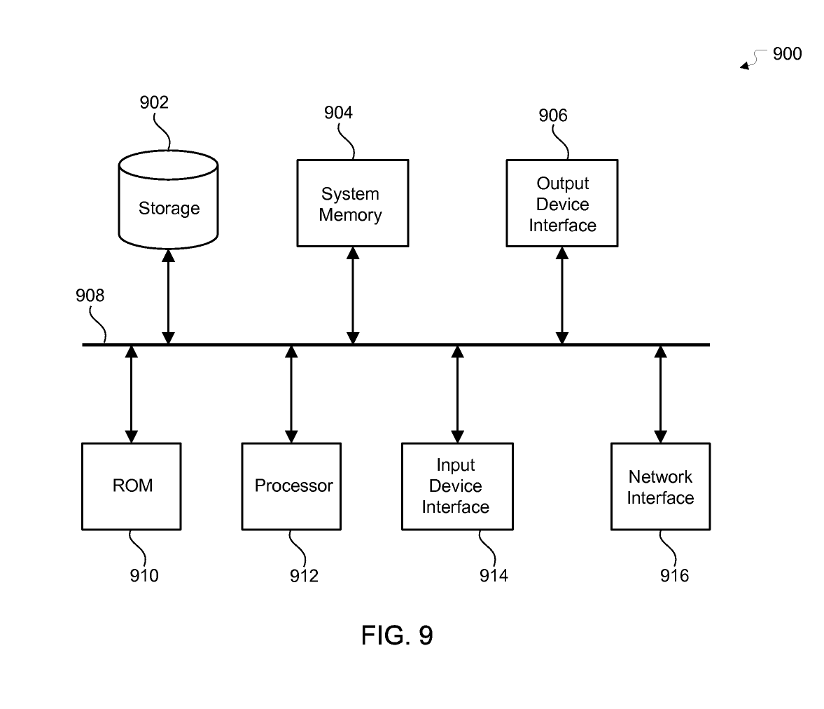

FIG. 9 conceptually illustrates electronic system 900 with which any implementations of the subject technology are implemented. Electronic system 900, for example, can be a desktop computer, a laptop computer, a tablet computer, a server, a switch, a router, a base station, a receiver, a phone, a personal digital assistant (PDA), any device that provides or receives repeating time intervals, or generally any electronic device that transmits signals over a network. Such an electronic system includes various types of computer readable media and interfaces for various other types of computer readable media. Electronic system 900 includes bus 908, processing unit(s) 912, system memory 904, read-only memory (ROM) 910, permanent storage device 902, input device interface 914, output device interface 906, and network interface 916, or subsets and variations thereof.

Bus 908 collectively represents all system, peripheral, and chipset buses that communicatively connect the numerous internal devices of electronic system 900. In one or more implementations, bus 908 communicatively connects processing unit(s) 912 with ROM 910, system memory 904, and permanent storage device 902. From these various memory units, processing unit(s) 912 retrieves instructions to execute and data to process in order to execute the processes of the subject disclosure. The processing unit(s) can be a single processor or a multi-core processor in different implementations.

ROM 910 stores static data and instructions that are needed by processing unit(s) 912 and other modules of the electronic system. Permanent storage device 902, on the other hand, is a read-and-write memory device. This device is a non-volatile memory unit that stores instructions and data even when electronic system 900 is off. One or more implementations of the subject disclosure use a mass-storage device (such as a magnetic or optical disk and its corresponding disk drive) as permanent storage device 902.

Other implementations use a removable storage device (such as a floppy disk, flash drive, and its corresponding disk drive) as permanent storage device 902. Like permanent storage device 902, system memory 904 is a read-and-write memory device. However, unlike storage device 902, system memory 904 is a volatile read-and-write memory, such as random access memory. System memory 904 stores any of the instructions and data that processing unit(s) 912 needs at runtime. In one or more implementations, the processes of the subject disclosure are stored in system memory 904, permanent storage device 902, and/or ROM 910. From these various memory units, processing unit(s) 912 retrieves instructions to execute and data to process in order to execute the processes of one or more implementations.

Bus 908 also connects to input and output device interfaces 914 and 906. Input device interface 914 enables a user to communicate information and select commands to the electronic system. Input devices used with input device interface 914 include, for example, alphanumeric keyboards and pointing devices (also called “cursor control devices”). Output device interface 906 enables, for example, the display of images generated by electronic system 900. Output devices used with output device interface 906 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 9, bus 908 also couples electronic system 900 to a network (not shown) through network interface 916. In this manner, the computer can be a part of a network of computers (such as a local area network (“LAN”), a wide area network (“WAN”), or an Intranet, or a network of networks, such as the Internet. Any or all components of electronic system 900 can be used in conjunction with the subject disclosure.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more implementations, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more implementations, the computer readable media is non-transitory computer readable media, computer readable storage media, or non-transitory computer readable storage media.

In one or more implementations, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Terms such as “top,” “bottom,” “front,” “rear” and the like as used in this disclosure, if any, should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A computer-implemented method for receiving a repeating time interval, the method comprising:
providing for display, using one or more computing devices, an interface for inputting one or more time intervals that repeat over a period of time, wherein the interface comprises at least one field for inputting the one or more time intervals and a plurality of selectors for indicating one or more frequencies at which the one or more time intervals repeat over the period of time;
receiving, using the one or more computing devices, a user input of a first indication of a first time interval and another user input of a first frequency at which the first time interval repeats over the period of time, wherein the first frequency is indicated exclusively by a first selection of a first selector of the plurality of selectors;
storing, using the one or more computing devices and in response to the receiving, the first time interval and the first frequency at which the first time interval repeats over the period of time; and
providing for display to a user, using the one or more computing devices, a representation of the first-time interval and each instance that the first time interval repeats over the period of time.

2. The method of claim 1, further comprising:
providing for display, using the one or more computing devices, a representation of the first time interval and each instance that the first time interval repeats over the period of time.

3. The method of claim 2, wherein the period of time comprises a week and the one or more time intervals are within a day of the week.

4. The method of claim 3, wherein the first indication of the first time interval and the first frequency at which the first time interval repeats over the period of time is indicative of a first set of days of the week that the first time interval repeats on.

5. The method of claim 4, further comprising:
providing for display, using the one or more computing devices, a representation of the first time interval and each day of the first set of days of the week that the first time interval repeats on.

6. The method of claim 4, further comprising:
receiving, using the one or more computing devices, a second indication of a second time interval and a second frequency at which the second time interval repeats over the week, the second indication being indicative of a second set of days of the week that the second time interval repeats on, wherein the second frequency is indicated exclusively by a second selection of a second selector of the plurality of selectors, the second frequency is distinct from the first frequency, and the first set of days of the week and the second set of days of the week have at least one day of the week in common; and
storing, using the one or more computing devices, the second time interval and the second frequency at which the second time interval repeats over the period of time.

7. The method of claim 3, wherein the plurality of selectors comprises a first selector that indicates that the one or more time intervals repeat on all days of the week, a second selector that indicates that the one or more time intervals repeat only on weekdays, and a third selector that indicates that the one or more time intervals repeat only on weekends.

8. The method of claim 7, wherein the plurality of selectors further comprises a fourth selector that indicates that the one or more time intervals repeat on user-customized days of the week.

9. The method of claim 8, further comprising:
providing for display, using the one or more computing devices and in response to receiving a second selection of the fourth selector that indicates that the first time interval repeats on the user-customized days of the week, a separate interface for inputting the user customized days of the week.

10. The method of claim 9, further comprising:
providing for display, using the one or more computing devices and in response to receiving the user-customized days of the week, the interface for inputting the one or more time intervals that repeat over the period of time.

11. The method of claim 1, wherein the first time interval repeats over the period of time on an aperiodic basis.

12. A computer-implemented system for receiving a repeating time interval, comprising:
one or more processors; and
a memory including instructions that, when executed by the one or more processors, cause the one or more processors to:
provide for display an interface for inputting one or more time intervals that repeat over a period of time, wherein the interface comprises at least one field for inputting the one or more time intervals and a plurality of selectors for indicating one or more frequencies at which the one or more time intervals repeat over the period of time;
receive a user input of a first indication of a first time interval and another user input of a first frequency at which the first time interval repeats over the period of time, wherein the first frequency is indicated exclusively by a first selection of a first selector of the plurality of selectors; and
provide for display to a user, in response to the receive, a first representation of the first time interval and each instance that the first time interval repeats over the period of time.

13. The system of claim 12, wherein the period of time comprises a week, the first time interval is within a day of the week, and the first frequency at which the first time interval repeats over the period of time comprises a first plurality of days of the week that the first time interval repeats on.

14. The system of claim 13, further comprising instructions that, when executed by the one or more processors, cause the one or more processors to:
receive a second indication of a second time interval and a second frequency at which the second time interval repeats over the week, the second indication being indicative of a second plurality of days of the week that the second time interval repeats on, wherein the second frequency is indicated exclusively by a second selection of a second selector of the plurality of selectors and the second frequency is equal to the first frequency; and
provide for display the first representation of the first time interval and each instance that the first time interval repeats over the period of time and a second representation of the second time interval and each instance that the second time interval repeats over the period of time.

15. The system of claim 13, further comprising instructions that, when executed by the one or more processors, cause the one or more processors to:
store the first time interval and the plurality of days of the week that the first time interval repeats on.

16. The system of claim 13, wherein the provide, for display and in response to the receive, the first representation of the first time interval and each instance that the first time interval repeats over the period of time further comprises provide, for display and in response to the receive, the first representation of the time interval and each of the plurality of days of the week that the first time interval repeats on.

17. The system of claim 13, wherein the plurality of selectors comprises a first selector that indicates that the one or more time intervals repeat on all days of the week, a second selector that indicates that the one or more time intervals repeat only on weekdays, and a third selector that indicates that the one or more time intervals repeat only on weekends.

18. The system of claim 17, wherein the plurality of selectors further comprises a fourth selector that indicates that the one or more time intervals repeat on user-customized days of the week.

19. The system of claim 18, further comprising instructions that, when executed by the one or more processors, cause the one or more processors to:
provide for display, in response to receiving a second selection of the fourth selector that indicates that the one or more time intervals repeat on the user-customized days of the week, a separate interface for inputting the user-customized days of the week.

20. The system of claim 19, further comprising instructions that, when executed by the one or more processors, cause the one or more processors to:
provide for display, in response to receiving the user-customized days of the week, the interface for inputting the one or more time intervals that repeat over the period of time.

21. A non-transitory machine readable medium embodying instructions that, when executed by a machine, cause the machine to perform a method for providing a repeating time interval, the method comprising:
receiving for display an interface for inputting one or more time intervals that repeat over a period of time, wherein the interface comprises at least one field for inputting the one or more time intervals and a plurality of selectors for indicating one or more frequencies at which the one or more time intervals repeat over the period of time;
providing a user inputted first time interval via the at least one field;
providing a user inputted first indication of a first frequency at which the first time interval repeats over the period of time exclusively by selecting a first selector of the plurality of selectors; and
receiving for display to a user a first representation of the first time interval and each instance that the first time interval repeats over the period of time.

22. The non-transitory machine readable medium of claim 21, wherein the first time interval is within a day, the period of time comprises a week, and the first frequency at which the first time interval repeats over the period of time comprises a first plurality of days of the week that the first time interval repeats on.

23. The non-transitory machine readable medium of claim 22, wherein the receiving the representation of the first time interval and each instance that the first time interval repeats over the period of time further comprises receiving the representation of the first time interval and each of the first plurality of days of the week that the first time interval repeats on.

24. The non-transitory machine readable medium of claim 23, wherein the method further comprises:
providing a second time interval via the at least one field; and
providing a second indication of a second frequency at which the second time interval repeats over the period of time exclusively by selecting a second selector of the plurality of selectors, the second indication being indicative of a second plurality of days of the week that the second time interval repeats on, wherein the first and second plurality of days have at least one day in common and the representation further comprises the second time interval and each of the second plurality of days of the week that the second time interval repeats on.

25. The non-transitory machine readable medium of claim 22, wherein the plurality of selectors comprises a first selector that indicates that the one or more time intervals repeat on all days of the week, a second selector that indicates that the one or more time intervals repeat only on weekdays, and a third selector that indicates that the one or more time intervals repeat only on weekends.

26. The non-transitory machine readable medium of claim 21, wherein the least one field for inputting the time interval comprises a first field for inputting a start of the time interval and a second field for inputting an end of the time interval.

27. The non-transitory machine readable medium of claim 26, wherein the interface further comprises a spinner for inputting the start of the time interval and the end of the time interval.
